(19) United States
(12) Patent Application Publication
(10) Pub. No.: US 2014/0268128 A1
(43) Pub. Date: Sep. 18, 2014

(54) Self-Exciting Surface Enhanced Raman Spectroscopy

(71) Applicant: HEWLETT-PACKARD DEVELOPMENT COMPANY, L.P., (US)

(72) Inventors: Shih-Yuan Wang, Palo Alto, CA (US); Gary Gibson, Palo Alto, CA (US); Zhiyong Li, Foster City, CA (US); Huei Pei Kuo, Cupertino, CA (US); Alexandre M. Bratkovski, Mountain View, CA (US); Zhang-Lin Zhou, Palo Alto, CA (US)

(73) Assignee: HEWLETT-PACKARD DEVELOPMENT COMPANY, L.P., Houston, TX (US)

(21) Appl. No.: 13/797,880

(22) Filed: Mar. 12, 2013

(51) Int. Cl. G01N 21/65

(52) U.S. Cl. CPC G01N 21/658
USPC 356/301

(57) ABSTRACT

Self-exciting surface enhanced Raman spectroscopy (SERS) employs an integral optical excitation source to provide an excitation signal to provide self-excitation of a SERS structure. The SERS structure includes a plurality of nanofingers having SERS-enhancing nanoparticles disposed adjacent to the nanofingers.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Detection and identification (or at least classification) of unknown substances have long been of great interest and have taken on even greater significance in recent years. Among methodologies that hold particular promise for precision detection and identification are various forms of spectroscopy. Spectroscopy may be used to analyze, characterize and identify a substance or material using one or more of an absorption spectrum, a scattering spectrum and an emission spectrum that results when the material is illuminated by a form of electromagnetic radiation (e.g., visible light). The absorption, scattering and emission spectra produced by illuminating the material determine a spectral ‘fingerprint’ of the material. In general, the spectral fingerprint is characteristic of the particular material to facilitate identification of the material. Among the most powerful of optical emission spectroscopy techniques are those based on Raman scattering.

Scattering spectroscopy is an important means of identifying, monitoring and characterizing a variety of analyte species (i.e., analytes) ranging from relatively simple inorganic chemical compounds to complex biological molecules. Among the various types of scattering spectroscopy are methodologies that exploit Raman scattering and emission due to fluorescence (e.g., fluorescence emission) from an analyte. In general, scattering spectroscopy employs a signal (e.g., optical beam) to excite the analyte that, in turn, produces a response or scattered or emitted signal that is dependent on a characteristic (e.g., constituent elements or molecules of) the analyte. By detecting and analyzing the scattered or emitted signal (e.g., using spectral analysis), the analyte may be identified and even quantified, in some instances.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1A illustrates a cross sectional view of a self-exciting surface enhanced Raman spectroscopy (SERS) substrate, according to an example consistent with the principles described herein.

FIG. 1B illustrates a perspective view of the self-exciting SERS substrate of FIG. 1A, according to an example consistent with the principles described herein.

FIG. 2A illustrates a top view of a multimer having two nanofingers with attached nanoparticles arranged as a dimer, according to an example consistent with the principles described herein.

FIG. 2B illustrates top view of a multimer having three nanofingers with attached nanoparticles arranged as a trimer, according to an example consistent with the principles described herein.

FIG. 2C illustrates top view of a multimer having four nanofingers with attached nanoparticles arranged as a tetramer, according to an example consistent with the principles described herein.

FIG. 3A illustrates a cross sectional view of nanofingers including a Bragg mirror, according to an example consistent with the principles described herein.

FIG. 3B illustrates a cross sectional view of nanofingers including a Bragg mirror, according to another example consistent with the principles described herein.

FIG. 3C illustrates a cross sectional view of nanofingers including a Bragg mirror, according to another example consistent with the principles described herein.

FIG. 4A illustrates a perspective view of a self-exciting SERS substrate configured to be optically pumped, according to an example consistent with the principles described herein.

FIG. 4B illustrates a cross sectional view of a self-exciting SERS substrate configured to be electrically pumped, according to an example consistent with the principles described herein.

FIG. 5 illustrates a block diagram of a self-exciting surface enhanced Raman spectroscopy (SERS) sensor, according to an example consistent with the principles described herein.

FIG. 6A illustrates a perspective view of the self-exciting SERS sensor illustrated in FIG. 5, according to an example consistent with the principles described herein.

FIG. 6B illustrates a perspective view of the self-exciting SERS sensor illustrated in FIG. 5, according to another example consistent with the principles described herein.

FIG. 7 illustrates a cross section of the self-exciting SERS sensor, according to an example consistent with the principles described herein.

FIG. 8 illustrates a block diagram of a self-exciting SERS system, according to an example consistent with the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein provide detecting or sensing the presence of an analyte or a target species using scattering spectroscopy, e.g., surface enhanced Raman spectroscopy (SERS). In particular, examples in according with the principles described herein provide detecting or sensing an analyte with a SERS structure and that employs an integral optical excitation source to generate an optical excitation signal. As such, the surface enhanced Raman spectroscopy is ‘self-exciting,’ according to various examples of the principles described herein. Among other characteristics, surfaced enhanced Raman spectroscopy that is self-exciting may facilitate implementations that are uniquely compact. Further, self-excitation with an integral optical excitation source may provide higher level Raman scattering signals and thus better detection and sensing due to potentially higher localized power levels of the optical excitation signals given the proximity of the optical excitation source and a surface or structure employed in the surface enhanced Raman spectroscopy.

Herein, other applicable forms of scattering spectroscopy that may be used include, but are not limited to, surface enhanced coherent anti-stokes Raman scattering (SECARS), resonant Raman spectroscopy, hyper Raman spectroscopy, various spatially offset and confocal versions of Raman spectroscopy, as well as direct monitoring of plasmonic resonances. SERS may provide detection and identification of the analyte and in some examples, quantification of the analyte. In particular, the detection or sensing may be provided for an analyte that is either adsorbed onto or closely associated with a surface in SERS, according to various examples. Herein, the scattering spectroscopy will generally be described with reference to SERS-based scattering spectroscopy for simplicity of discussion and not by way of specific limitation, unless otherwise indicated.

Raman-scattering optical spectroscopy or simply Raman spectroscopy, as referred to herein, employs a scattering spectrum or spectral components thereof produced by inelastic scattering of photons by an internal structure of a material being illuminated or ‘excited’. These spectral components contained in a response signal (e.g., a Raman scattering signal) produced by the inelastic scattering may facilitate determination of the material characteristics of an analyte species including, but not limited to, identification of the analyte. Surface enhanced Raman spectroscopy (SERS) is a form of Raman spectroscopy that employs a ‘Raman-enhancing’ surface. SERS may significantly enhance a signal level or intensity of the Raman scattering signal produced by a particular analyte species. In particular, in some instances, the Raman-enhancing surface includes a region associated with the tips of nanostructures such as, but not limited to, nanofingers or nanorods. The tips of the nanofingers may serve as nanoantennas to one or both of concentrate a stimulus or excitation field and amplify a Raman emission leading to further enhancement of the strength of the Raman scattering signal, for example.

In some examples of SERS, a SERS surface that includes a plurality of nanofingers is configured to enhance production and emission of the Raman scattering signal from an analyte. Specifically, an electromagnetic field associated with and surrounding the nanofingers (e.g., tips of the nanofingers) in a ‘Raman-enhancing’ configuration may enhance Raman scattering from the analyte, in some examples. A relative location of the nanofingers themselves as well as tips of the nanofingers in the Raman-enhancing configuration may provide enhanced Raman scattering. Concentration of the excitation field and amplification of the Raman scattering signal may be associated with plasmonic modes supported by the nanostructures, according to various examples. The plasmonic modes may provide or produce so-called ‘hotspots’ in a scattering spectroscopy enhancing structure that includes the nanostructures, for example.

Herein, a ‘hotspot’ or more precisely a ‘SERS hotspot’ is defined with respect to scattering spectroscopy as a region or location on a substrate, or more generally within a scattering spectroscopy enhancing structure, that exhibits a spatially localized enhancement of an electromagnetic field. The SERS hotspot may be act as a ‘field concentrator’ to concentrate and locally enhance an incident electromagnetic field, for example. In various examples, the localized enhancement may be associated with one or both of an incident or excitation signal (i.e., incident electromagnetic field) used to stimulate the scattering spectroscopy enhancing structure and the production and subsequent radiation of the scattering signal. In particular, at the SERS hotspot, localized electromagnetic fields are enhanced by characteristics of the scattering spectroscopy enhancing structure. The SERS hotspot may be due to spatially localized surface plasmon resonances associated with the scattering spectroscopy enhancing structure, for example. In some examples, the electromagnetic field enhancement due to the SERS hotspot may result in electromagnetic fields that are orders of magnitude higher in a vicinity of the SERS hotspot than in regions outside of the SERS hotspot as well as in an electromagnetic wave (e.g., optical stimulus or optical excitation signal) used to excite the SERS hotspot. Note that, while a particular structure may represent a SERS hotspot, a SERS hotspot is only ‘hot’ when in the presence of the optical excitation signal, according to various examples.

According to various examples, the electromagnetic field enhancement is associated with physical characteristics of the scattering spectroscopy enhancing structure including, but not limited to, a shape of elements (e.g., nanoparticles or nanostructures) that make up the scattering spectroscopy nanostructure, the materials and the material properties (e.g., losses) of the elements, and an arrangement of the elements (e.g., nanoparticles adjacent or nearly adjacent to one another). The electromagnetic field enhancement at the SERS hotspot may also be related to characteristics of the electromagnetic field including, but not limited to, a frequency of and an angle of incidence of an excitation signal used to excite the SERS hotspot. The electromagnetic field enhancement at the SERS hotspot may, in turn, produce an enhancement of a scattering signal produced by an analyte in a vicinity of the SERS hotspot, according to various examples.

A ‘nanorod’ or equivalently a ‘nanofinger’ herein is defined as an elongated, nanoscale structure having a length (or height) that exceeds a nanoscale cross sectional dimension (e.g., width) taken in a plane perpendicular to the length, for example. In some examples, the length may exceed by several times the nanoscale cross sectional dimension. In particular, the length of the nanofinger is generally much greater than the nanofinger width (e.g., length is greater than about 2-3 times the width). In some examples, the length may exceed the cross sectional dimension (or width) by more than a factor of 5 or 10.

For example, the width may be about 40 nanometers (nm) and the height may be about 400 nm. In another example, the nanofinger width or diameter may be between about 100 nm and 200 nm and the length may exceed about 500 nm. For example, the width may be about 130 to about 170 nm and the length may be about 500 to about 800 nm. In yet another example, the width at a base of the nanofinger may range between about 20 nm and about 100 nm and the length may be more than about 1 micrometer (μm). In another example, the nanofinger may be conical with a base having a width ranging from between about 100 nm and about 500 nm and a length that may range between about one half (0.5) μm and several micrometers.

In various examples, nanofingers of the plurality may be grown (i.e., produced by an additive process) or produced by etching or a subtractive process. For example, the nanofingers may be grown as nanowires using a vapor-liquid-solid (VLS) growth process. In other examples, nanowire growth may employ one of a vapor-solid (V-S) growth process and a solution growth process. In yet other examples, growth may be realized through directed or stimulated self-organization techniques such as, but not limited to, focused ion beam (FIB) deposition and laser-induced self assembly. In another example, the nanofingers may be produced by using an etching process such as, but not limited to, reactive ion etching, to remove surrounding material leaving behind the nanofingers. In yet other examples, various forms of imprint lithography including, but not limited to, nanoimprint lithography as well as various techniques used in the fabrication of micro-electromechanical systems (MEMS) and nano-electromechanical systems (NEMS) are applicable to the fabrication of the nanofingers and various other elements described herein.

A ‘nanoparticle’ herein is defined as a nanoscale structure having substantially similar dimensions of length, width and depth. For example, the shape of a nanoparticle may be a cylinder, a sphere, an ellipsoid, or a faceted sphere or ellipsoid, or a cube, an octahedron, a dodecahedron, or another polygon. The nanoparticle may be a substantially irregular three-dimensional shape, in other examples. The size of the nanoparticle may range from about 5 nm to about 300 nm, for example, in diameter or dimension. In some examples, the nanoparticle dimensions may be within a range of about 50 nm to about 100 nm, or about 25 nm to about 100 nm, or about 100 nm to about 200 nm, or about 10 nm to about 150 nm, or about 20 nm to about 200 nm.

In some examples, a nanoparticle may be a substantially homogeneous structure. For example, the nanoparticle may be a nanoscale metal particle (e.g., a nanoparticle of gold, silver, copper, etc.). In other examples, the nanoparticle may be a core-shell structure that is substantially inhomogeneous, by definition. For example, the nanoparticle may include a core of a first material that is coated by a second material that may be different from the first material. The second material of the coating or shell may be a metal while the first material may be either a conductor or a dielectric material. In another example, the second material may be a dielectric and the first material may be a conductor such as a metal, for example. A nanoparticle that is capable of supporting a plasmon (e.g., either a surface plasmon or a bulk plasmon) is defined as a ‘plasmonic nanoparticle’. For example, a metal nanoparticle or a metal clad nanoparticle may serve as a plasmonic nanoparticle.

By definition herein, ‘nanoscale’ means a dimension that is generally less than about 1000 nanometers (nm). For example, a structure or particle that is about 5 nm to about 300 nm in extent is considered a nanoscale structure. Similarly, a slot having an opening size of between about 5 nm and 100 nm is also considered a nanoscale structure, for example.

Further, as used herein, the article ‘a’ is intended to have its ordinary meaning in the patent arts, namely ‘one or more’. For example, ‘a nanofinger’ means one or more nanofingers and as such, ‘the nanofinger’ means ‘the nanofinger(s)’ herein. Also, any reference herein to ‘top’, ‘bottom’, ‘upper’, ‘lower’, ‘up’, ‘down’, ‘front’, back′, ‘left’ or ‘right’ is not intended to be a limitation herein. Herein, the term ‘about’ when applied to a value generally means within the tolerance range of the equipment used to produce the value, or in some examples, means plus or minus 10%, or plus or minus 5%, or plus or minus 1%, unless otherwise expressly specified. Moreover, examples herein are intended to be illustrative only and are presented for discussion purposes and not by way of limitation.

FIG. 1A illustrates a cross sectional view of a self-exciting surface enhanced Raman spectroscopy (SERS) structure 100, according to an example consistent with the principles described herein. FIG. 1B illustrates a perspective view of the self-exciting SERS structure 100 of FIG. 1A, according to an example consistent with the principles described herein. As illustrated, the self-exciting SERS structure 100 is configured to sense an analyte in a vicinity of the self-exciting SERS structure 100. For example, the analyte may be suspended in and carried by a fluid that flows through or past the self-exciting SERS structure 100, for example. According to various examples, the self-exciting SERS structure 100 senses the analyte by producing a Raman scattering signal through an inelastic interaction between an excitation signal and the analyte. Furthermore, the excitation signal is produced by the self-exciting SERS structure 100 itself (i.e., providing self-excitation of the Raman scattering signal), according to various examples. In particular, the self-exciting SERS structure 100 includes an integral optical excitation source, according to various examples.

As illustrated, the self-exciting SERS structure 100 includes a plurality of nanofingers 110 that includes one or more nanolasers 112. In particular, a nanofinger 110 of the plurality includes an optical gain material to provide stimulated emission (e.g., of photons) and an optical cavity to provide optical feedback. The combination of the optical gain material and the optical cavity yield a nanolaser 112, according to various examples. In some examples, each nanofinger 110 of the plurality is so configured as nanolasers 112. The nanolaser 112 of the nanofinger 110 is configured to provide an optical excitation signal. In particular, the optical excitation signal is provided through light amplification by stimulated emission of radiation (i.e., photons produced by lasing) within the optical cavity employing the optical feedback, according to various examples. In some examples, the excitation signal is, or at least includes, the optical excitation signal produced by the nanolasers 112 of the respective nanofingers 110. As such, the nanolasers 112 are the integral optical excitation source, according to various examples.

In some examples, the nanofingers 110 have a distal or free end longitudinally opposite to another end that is attached to or otherwise supported by (e.g., a ‘fixed’ end) a supporting substrate 114. For example, the nanofinger 110 may be rigidly attached to the supporting substrate 114 at the fixed end. In other examples, the nanofingers 110 of the plurality may be indirectly attached to the supporting substrate 114 through an intermediate material or layer, for example. In yet other examples (not illustrated in FIGS. 1A-1B), the nanofingers are not attached to the supporting substrate at either longitudinally opposite ends (e.g., both ends are free). For example, the nanofingers 110 may be distributed or laying in a substantially horizontal configuration on the supporting substrate 114, while not being attached at either of the ends of the nanofinger 110.

In various examples, the nanofinger 110 or a portion thereof may be configured to preferentially capture or retain the analyte in a vicinity of the nanofinger 110. For example, a surface of the nanofinger 110 may adsorb or bind the analyte. In some examples, the nanofingers 110 or a portion thereof may be functionalized to preferentially bind or provide selective adsorption of the analyte. In some examples, the nanofingers 110 may actively capture or trap the analyte (e.g., by a motion of the nanofingers 110).

In some examples, the optical gain material of the nanofinger 110 may include a semiconductor. In particular, any semiconductor or hybrid semiconductor combination (e.g., various metal-semiconductor combinations) that provides optical gain may be employed. For example, the semiconductor may be or include a doped or undoped (i.e., substantially intrinsic or unintentionally doped) semiconductor such as various III-V and II-VI compound semiconductors including, but not limited to, one or more of gallium arsenide (GaAs), indium gallium arsenide (InGaAs), gallium nitride (GaN), gallium antimonide (GaSb) indium phosphide (InP). In other examples, the nanofinger 110 may include a solid host material doped with an impurity. The solid host material may include, but is not limited to, yttrium aluminum garnet (YAG), yttrium lithium fluoride (YLF), sapphire (aluminum oxide), and various glasses, while the impurity dopant may include, but is not limited to, chromium (Cr), neodymium (Nd), erbium (Er) and titanium (Ti). In yet other examples, the nanofinger 110 may be or include a plastic or a polymer such as, but not limited to, polyfluorene or polymethyl methacrylate (PMMA) doped with a perylimide dye, and related plastics and plastic/dye combinations that exhibit stimulated emission when pumped by an optical pump, for example.

According to various examples, the self-exciting SERS structure 100 further includes a nanoparticle 120 disposed adjacent to the nanofingers 110. In some examples (e.g., as illustrated), the adjacent nanoparticle 120 is disposed on the free end of the nanofinger 110. For example, the nanoparticle 120 may be attached to the free end of the nanofinger 110 opposite to the fixed end that is attached to the supporting substrate, as illustrated in FIGS. 1A and 1B. In other examples (not illustrated), the nanoparticle may be attached or otherwise located or associated with a longitudinal side of the nanofinger.

According to various examples, the optical excitation signal provided by the nanofingers 110 that include nanolasers 112 is configured to illuminate the nanoparticles 120. In particular, according to some examples, the nanofinger 110 acting as a nanolaser 112 may preferentially emit the optical excitation signal through the ends of the nanofinger 110, including the free end at which the nanoparticle 120 is located. The optical excitation signal may be substantially concentrated in a vicinity of the nanoparticle 120 located at the end of the nanofinger 110, for example. When the nanoparticle 120 is located at the side of the nanofinger 110, the optical excitation signal emitted from an end of the nanofinger 110 may illuminate a nanoparticle 120 of an adjacent nanofinger 110, for example. In another example, an evanescent field of the optical excitation signal within the nanofinger 110 may couple to and thus ‘illuminate’ the nanoparticle 120 at the side of the nanofinger 110.

According to various examples, the nanoparticle 120 includes a SERS-enhancing material. In particular, a material of the nanoparticle 120 is configured to enhance Raman scattering from an adjacent analyte. The SERS-enhancing material may be substantially any material that supports a surface plasmon, according to various examples. In other examples, the nanoparticles 120 may support a bulk plasmon. In some examples, the SERS-enhancing material of the nanoparticle 120 is a conductive material such as a metal. For example, the metal may include, but is not limited to, gold, silver, platinum, other noble metals, aluminum, copper, as well as an alloy or a mixture of any of these metals with each other or another metal. The nanoparticle 120 may be a gold catalyst nanoparticle used to grow the nanofinger 110 using VLS growth, for example.

In some examples, the nanoparticle 120 may include substantially only the conductive material (e.g., the metal). For example, the nanoparticles 120 may be metal nanoparticles 120. In other examples, the conductor material (e.g., the metal) may be used to form a surface of the nanoparticles 120. For example, the nanoparticles 120 may include a metal shell surrounding a core of another material such as, but not limited to, a semiconductor or a dielectric. In some examples, the nanofinger 110 itself may also support one or both of surface plasmons and bulk plasmons (e.g., when the nanofinger 110 is or includes an electrically conductive material such as metal). For example, the nanofinger 110 may include a metallic surface either along an entire length of the nanofinger 110 or in a vicinity of the tip at the free end. The presence of surface plasmons and bulk plasmons may be responsible for rendering one or both of the nanofinger 110 and the nanoparticle 120 Raman-enhancing, according to various examples.

In some examples, the nanoparticle 120 may be functionalized to preferentially adsorb the analyte. For example, the surface of a metal nanoparticle 120 may be functionalized to preferentially bind with particular analyte species. The surface functionalization may be provided by a metal-oligonucleotide conjugate to preferentially bind various molecules such as, but not limited to, DNA, RNA, or segments of either thereof, for example.

According to some examples, the plurality of nanofingers 110 with nanoparticles 120 disposed on the nanofingers 110 are arranged as an ordered group or array on the supporting substrate 114. In some examples, the ordered array includes a ‘multimer’ of nanofingers 110 with attached nanoparticles 120. A nanofinger 110 of the multimer includes a nanolaser 112, or in some examples, each nanofinger 110 of the multimer includes a nanolaser 112. The ordered array including a multimer of nanofingers 110 is configured to provide a SERS hotspot between adjacent ones of the nanoparticles 120 disposed on the free ends of the nanofingers 110 in the multimer, according to some examples.

According to various examples, the multimer may include a group of two, three, four, five, six or more nanofingers 110. A multimer having two nanofingers 110 may be referred to as a ‘dimer,’ a multimer having three nanofingers 110 may be referred to as ‘trimer,’ a multimer having four nanofingers 110 may be referred to as a ‘tetramer,’ and so on. In some examples, the nanofingers 110 of the multimer may be arranged such that at least the free ends of the nanofingers 110 with attached nanoparticles 120 are located at vertices of a polygon (e.g., a digon, a trigon, a tetragon, a pentagon, a hexagon, and so on). The polygon may be a regular polygon, in some examples.

FIG. 2A illustrates a top view of a multimer 116 having two nanofingers 110 with attached nanoparticles 120 arranged as a dimer, according to an example consistent with the principles described herein. FIG. 2B illustrates top view of a multimer 116 having three nanofingers 110 with attached nanoparticles 120 arranged as a trimer, according to an example consistent with the principles described herein. FIG. 2C illustrates top view of a multimer 116 having four nanofingers 110 with attached nanoparticles 120 arranged as a tetramer, according to an example consistent with the principles described herein.

According to various examples, the nanoparticles 120 of the multimer 116 may be either touching one another or spaced apart from one another. For example, the nanoparticles 120 on the tips of the nanofingers 110 in the multimer 116 may be substantially touching or in close proximity, such that they are separated by a gap of about a few nanometers or less. Further, the nanofingers 110 in the multimer 116 may be tilted such that their tips with the attached nanoparticles 120 lean toward one another. The tilting may facilitate contact between the nanoparticles 120 on the tips of the nanofingers 110, for example.

In some examples, the self-exciting SERS structure 100 may include a plurality of multimers 116. For example, the plurality of multimers 116 may include several, tens, hundreds, or more multimers 116. The multimers 116 may be spaced apart from one another across the support substrate 114, for example. In other examples, the multimers 116 may be immediately adjacent or even touching one another (e.g., a nanoparticle 120 of a first multimer 116 may touch a nanoparticle 120 of an adjacent SERS multimer 116). A spacing between the SERS multimers 116 of the plurality when spaced apart may be either regular (i.e., a periodic spacing) or irregular (e.g., a substantially random spacing), according to various examples.

In particular, in some examples, the plurality of multimers 116 may be arranged in a particular repeating ordered pattern or an ‘array’ of multimers 116. The array of multimers 116, including both small arrays (e.g., bundles) and large arrays, may include, but is not limited to, a linear array or one-dimensional (1-D) array or a two-dimensional (2-D) array (e.g., a rectilinear array, a circular array, etc.). For example, a plurality of multimers 116 may be arranged in a row for a 1-D array. A plurality of 1-D arrays or rows of multimers 116 may be arranged next to one another to form a 2-D rectilinear array of multimers 116, for example. Various other 2-D arrays may be employed including, but not limited to, polygonal arrays and circular arrays.

Referring again to FIG. 1A and as mentioned above, the nanolaser 112 includes an optical cavity in the nanofinger 110 according to various examples. For example, the optical cavity may include the entire nanofinger 110 bounded by the longitudinal ends of the nanofinger 110. The ends of the nanofinger 110 may represent a material discontinuity (e.g., a change in dielectric constant) between the nanofinger 110 and air or a material of the supporting substrate 114, for example. The material discontinuity at two opposite ends may act as a pair of opposing mirrors to define the optical cavity, for example. In another example, the nanoparticle 120 on the free end of the nanofinger 110 may provide optical reflection and thus form one end of the optical cavity. A second end of the optical cavity may be formed at an interface between the supporting substrate 114 and the nanofinger 110 (e.g., due to a material discontinuity). In yet other examples, the nanofinger 110 may include one or more mirrors such as, but not limited to, Bragg mirrors to provide the optical cavity.

FIG. 3A illustrates a cross sectional view of nanofingers 110 including a Bragg mirror 118, according to an example consistent with the principles described herein. In particular, the nanofingers 110 include a Bragg mirror 118 adjacent to the free end and the nanoparticle 120 at the free end, as illustrated. The optical cavity may be provided or created between the Bragg mirror 118 and the supporting substrate 114, for example. The Bragg mirror 118 may be formed during growth of the nanofinger 110 by varying growth conditions, for example.

FIG. 3B illustrates a cross sectional view of nanofingers 110 including a Bragg mirror 118, according to another example consistent with the principles described herein. In particular, FIG. 3B illustrates the nanofingers 110 including two Bragg mirrors 118. A first Bragg mirror 118 is located adjacent to the free end of the nanofingers 110 and a second Bragg mirror 118′ is locate adjacent to an end of the nanofinger 110 that is adjacent to the supporting substrate 114 (e.g., the fixed end). The optical cavity is provided or created between the two Bragg mirrors 118, 118′, as illustrated.

FIG. 3C illustrates a cross sectional view of nanofingers 110 including a Bragg mirror 118, according to another example consistent with the principles described herein. In particular, FIG. 3C illustrates the nanofingers 110 including a first Bragg mirrors 118 to establish a first end of the optical cavity. A second Bragg mirror 118′ that forms a second end of the optical cavity is located in the supporting substrate 114, as illustrated. For example, the second Bragg mirror 118′ may be deposited on or formed in a surface of the supporting substrate 114 prior to attaching the nanofingers 110. In yet other examples (not illustrated), a surface of the supporting substrate 114 may include a reflective coating (e.g., a metal layer) that provides reflection to form the second end of the optical cavity. In each of FIGS. 3A-3C, the nanolaser 112 may be provided by the optical cavity associated with the Bragg mirrors, for example.

Referring again to FIGS. 1A and 1B, the self-exciting SERS structure 100 is configured to produce the optical excitation signal by ‘lasing’ in the optical material in conjunction with optical feedback provided by the optical cavity of the nanolasers 112 of the nanofingers 110. In some examples, the lasing may be provided by optical pumping, while in other examples, the lasing may be provided by electrical pumping. A pump source provides either the optical pumping or the electrical pumping, according to various examples.

In particular, in some examples, the nanolasers 112 of the nanofingers 110 are configured to be optically pumped by an optical pump source. The optical pump source may be a ‘light’ source such as a laser or a light emitting diode (LED) that illuminates the nanofingers 110, for example. Optical pumping produces photons by stimulated emission within the optical gain material. The photons then resonate within the optical cavity eventually producing the optical excitation signal, according to some examples. In some examples, the optical pump source includes a vertical cavity surface-emitting laser (VCSEL). The plurality of nanofingers 110 may be disposed on a surface of an output aperture of the VCSEL, for example. Light emitted by the VCSEL may provide optical pumping, according to some examples.

FIG. 4A illustrates a perspective view of a self-exciting SERS structure 100 configured to be optically pumped, according to an example consistent with the principles described herein. In particular, the self-exciting SERS structure 100 illustrated in FIG. 4A includes a plurality of nanofingers 110 disposed on a surface of an output aperture 132 of an optical pump source 130, e.g., a VCSEL. As illustrated, the optical pump source or VCSEL 130 is also the supporting substrate 114. Also as illustrated, the nanofingers 110 of the plurality are tilted toward one another in a configuration that may enhance trapping of an analyte 102, for example.

In other examples, the nanolasers 112 of the nanofingers 110 are configured to be electrically pumped by an electrical pump source 130 to provide the optical excitation signal. For example, the nanofingers 110 of the plurality may include a semiconductor junction. The electrical pump source 130 may include a voltage source connected across the semiconductor junction, for example. In various examples, the semiconductor junction may include, but is not limited to, a p-n junction, a p-i-n junction, a heterojunction. For example, the nanolaser 112 of the nanofinger 110 may be a double heterojunction laser or a quantum well laser that employs a heterojunction. In another example, a semiconductor junction may be formed between the nanofinger 110 and the supporting substrate 114.

FIG. 4B illustrates a cross sectional view of a self-exciting SERS structure 100 configured to be electrically pumped, according to an example consistent with the principles described herein. In particular, the self-exciting SERS structure 100 illustrated in FIG. 4A includes nanofingers 110 that include a p-n junction within the optical gain material (e.g., GaAs) of the nanolaser 112 within the nanofingers 110. Also illustrated is a voltage source V connected across the p-n junction to serve as the electrical pump source 130. The supporting substrate 114 may act as an electrical connection to the fixed end or a base of the nanofinger 110, for example, as illustrated. Note that the doping of the semiconductor junction may be reversed in the nanofingers 110 and still be within the scope of the example herein.

Although not explicitly illustrated in FIG. 4B, the connection of the voltage source across the semiconductor junction (e.g., the p-n junction) may be provided in any of a number of ways. For example, the self-exciting SERS structure 100 may further include a conductive layer (not illustrated) on top of the nanofingers 110. The conductive layer may be attached to the nanoparticles 120, for example. The voltage source V may be connected to the conductive layer, for example. In some examples, the conductive layer may be porous to enable an analyte (e.g., suspended in a fluid) to interact with (e.g., be adsorbed by) the nanoparticles 120. The porous conductive layer may include, but is not limited to, a conductive permeable membrane and a conductive mesh, for example. In another example, the conductive layer may be substantially nonporous (e.g., a solid conductor layer). When the conductive layer is substantially nonporous, the analyte may be introduced below the conductive layer in a space between the conductive layer and the supporting substrate 114, in some examples. For example, a fluid carrying the analyte may be introduced and caused to flow through the SERS structure from an end or an edge thereof between the supporting substrate 114 and the substantially nonporous conductive layer. In yet other examples, the nanoparticles 120 including a conductive material (e.g., the SERS-enhancing material) may be sufficiently close to one another to form a conduction path (i.e., the conductive layer) by themselves. Electrical connection may be made to an edge of the conductive layer formed by the nanoparticles 120, for example. In yet another example, the nanofingers 110 may be insulated (e.g., with an insulating shell) and a conductive fluid may be employed to carry the analyte. In this example, the voltage source V may be connected across the semiconductor junction using the conductive fluid.

According to some examples of the principles described herein, a self-exciting surface enhanced Raman spectroscopy (SERS) sensor is provided. FIG. 5 illustrates a block diagram of a self-exciting surface enhanced Raman spectroscopy (SERS) sensor 200, according to an example consistent with the principles described herein. FIG. 6A illustrates a perspective view of the self-exciting SERS sensor 200 illustrated in FIG. 5, according to an example consistent with the principles described herein. FIG. 6B illustrates a perspective view of the self-exciting SERS sensor 200 illustrated in FIG. 5, according to another example consistent with the principles described herein. According to various examples, the self-exciting SERS sensor 200 is configured to produce a Raman scattering signal from an analyte using an optical excitation signal provided by the self-exciting SERS sensor 200 itself.

As illustrated, the self-exciting SERS sensor 200 includes a SERS structure 210. In some examples (e.g., FIG. 6A), the SERS structure 210 includes a plurality of SERS-enhancing nanorods 212. The SERS-enhancing nanorods 212 include a SERS-enhancing material, according to various examples. For example, the SERS-enhancing nanorods 212 may include metal such as, but not limited to, gold, silver, platinum, other noble metals, aluminum, copper, as well as an alloy or a mixture of any of these metals with each other or another metal. In another example, the SERS-enhancing nanorods 212 may be metal nanorods or may be non-metal nanorods coated with the metal. In other examples, the SERS-enhancing nanorods 212 may include non-metal nanorods mixed together with nanoparticles that include a SERS-enhancing material. In yet other examples, the SERS-enhancing nanorods 212 may be a combination of one or both of metal nanorods and metal-coated non-metal nanorods along with nanoparticles that include a SERS-enhancing material.

In other examples (e.g., FIG. 6B), the SERS structure 210 may include a plurality of nanofingers 214 having SERS-enhancing nanoparticles 216 disposed at an end (e.g., a free end) of the nanofingers 214. According to various examples, the SERS-enhancing nanoparticles 216 include a SERS-enhancing material. In some examples, the SERS-enhancing nanoparticles 216 are substantially similar to the nanoparticles 120 described above with respect to the self-exciting SERS structure 100.

According to various examples, the nanofingers 214 may include one or both of a SERS-enhancing material (e.g., metal) and a substantially non-SERS-enhancing material. For example, the nanofinger 214 may include a semiconductor. The semiconductor may be doped or undoped (i.e., substantially intrinsic) silicon (Si), germanium (Ge) or an alloy of Si and Ge, for example. In other examples, the semiconductor may include one or more of gallium arsenide (GaAs), indium gallium arsenide (InGaAs), gallium nitride (GaN), or various other III-V, II-VI, and IV-VI compound semiconductors. In other examples, the nanofinger 214 may be or include a plastic or a polymer such as, but not limited to, polyurethane, poly(tert-butyl methacrylate) (P(tBMA)), polymethylmethacrylate (PMMA), polystyrene, polycarbonate or related plastics. In yet other examples, the nanofinger 112 may include a metal such as, but not limited to, gold, silver, platinum, other noble metals, aluminum copper, or an alloy or a combination of two or more metals.

As illustrated in FIGS. 5 and 6A-6B, the self-exciting SERS sensor 200 further includes a vertical cavity surface-emitting laser 220 (VCSEL). The VCSEL 220 is configured to produce an optical excitation signal 222 at an output aperture 224 of the VCSEL 220. According to various examples, the SERS structure 210 is disposed on a surface of the output aperture 224 of the VCSEL 220.

For example, as illustrated in FIG. 6A, the SERS-enhancing nanorods 212 may be disposed on the output aperture 224. In some examples, the SERS-enhancing nanorods 212 may be distributed in a substantially random fashion on the output aperture 224 (e.g., as illustrated). For example, the SERS-enhancing nanorods 212 may be suspended in a carrier liquid and deposited on the output aperture 224 using an inkjet printer or similar means. In other examples (not illustrated), the SERS-enhancing nanorods 212 may be distributed on the output aperture 224 in a substantially ordered fashion (e.g., as an ordered array). For example, the SERS-enhancing nanorods 212 may be attached to the surface of the output aperture 224 at a first end of the SERS-enhancing nanorods 212 with a second or opposite end extending generally away from the surface. The SERS-enhancing nanorods 212 may be arranged in an ordered array that includes multimers substantially similar to the multimers 116 described above with respect to the self-exciting SERS structure 100, for example.

Similarly, as illustrated in FIG. 6B, the plurality of nanofingers 214 may be disposed on the surface of the output aperture 224 of the VCSEL 220. In particular, the nanofingers 214 having SERS-enhancing nanoparticles 216 disposed at the free ends thereof may be attached to the output aperture surface at an end opposite the free end, as illustrated. In such a configuration, the nanofingers 214 may extend generally away from the output aperture surface.

According to various examples, the nanofingers 214 may be arranged in an ordered array on the output aperture surface. In some examples, the ordered array may include a multimer of adjacent nanofingers 214 to provide a SERS hotspot between adjacent ones of the nanoparticles 216 disposed on the free ends of the nanofingers 214 in the multimer. FIG. 6B illustrates a plurality of multimers having four nanofingers 214, for example. In other examples (not illustrated), the nanofingers 214 may be arranged in an ordered array that includes multimers substantially similar to the multimers 116 described above with respect to the self-exciting SERS structure 100. In some examples, the nanofingers 214 may be tilted (e.g., tilted toward one another), as illustrated in FIG. 4A.

In some examples, the nanofingers 214 may serve as a light guide to guide the optical excitation signal from the output aperture 224 to the nanoparticle 216. For example, the nanofingers 214 may include a dielectric material that serves as the light guide. For example, the nanofingers 214 may guide the optical excitation signal by total internal reflection. Alternatively, the nanofingers 214 may guide the optical excitation signal by another means including, but not limited, a sub wavelength optical guide or a surface plasmon waveguide, for example.

FIG. 7 illustrates a cross section of the self-exciting SERS sensor 200, according to an example consistent with the principles described herein. In particular, FIG. 7 illustrates the nanofingers 214 guiding the optical excitation signal 222 from the output aperture 224 of the VCSEL 220 to the nanoparticle 216. As illustrated, the optical excitation signal 222 is guided by total internal reflection.

Referring again to FIG. 5, in some examples, the self-exciting SERS sensor 200 may further include a filter 230 between the SERS structure 210 and the VCSEL 220. The filter 230 may be a thin film filter, for example. In some examples, the thin film filter 230 serves as the output aperture surface of the VCSEL 220. For example, the thin film filter 230 may be incorporated into a surface layer of the VCSEL 220. Alternatively, the thin film filter 230 may be deposited on the surface of the output aperture to provide a new surface on which the SERS structure 210 is disposed.

According to various examples, the filter 230 may be either a short-pass or bandpass filter configured to reduce or even substantially block optical signals from the VCSEL that may overlap in wavelength with the Raman scattering signal, for example. For example, the filter 230 may include Bragg layers that allow passage of the optical excitation signal but substantially block other (e.g., spontaneous emission) optical signals produced by the VCSEL 220.

According to some examples of the principles described herein, a self-exciting SERS system is provided. FIG. 8 illustrates a block diagram of a self-exciting SERS system 300, according to an example consistent with the principles described herein. As illustrated, the self-exciting SERS system 300 includes an integral optical excitation source 310. The integral optical excitation source 310 is configured to provide an optical excitation signal 312. The self-exciting SERS system 300 further includes a SERS-enhancing structure 320. The SERS-enhancing structure 320 is configured to be illuminated by the optical excitation signal 312 from the integral optical excitation source 310, according to various examples. In some examples, the illumination produces a Raman scattering signal 322 from an analyte in a vicinity of the SERS-enhancing structure 320. Together, the integral optical excitation source 310 and SERS-enhancing structure 320 provide a self-exciting SERS assembly 302 that may produce the Raman scattering signal 322 when exposed to the analyte, according to various examples.

In some examples, the SERS structure 320 includes a SERS-enhancing nanoparticle disposed on a free end of a nanofinger nanolaser. According to various examples, the SERS-enhancing nanoparticle includes a SERS-enhancing material. In some examples, the SERS-enhancing nanoparticle may be substantially similar to the nanoparticle 120 described above with respect to the self-exciting SERS structure 100. In particular, the SERS-enhancing material may include a metal such as, but is not limited to, gold, silver, platinum, other noble metals, aluminum, copper, as well as an alloy or a mixture of any of these metals with each other or another metal. The SERS-enhancing nanoparticle may include substantially only the SERS-enhancing material or may include another material that is coated with the SERS-enhancing material, for example.

According to various examples, the SERS-enhancing nanoparticle is disposed on a free end of a nanofinger nanolaser. The nanofinger nanolaser includes an optical gain material and an optical cavity. The optical gain material provides stimulated emission of radiation (e.g., photons) while the optical cavity is configured to provide optical feedback. Together the optical gain material and the optical cavity support light amplification by stimulated emission of radiation such that the nanofinger nanolaser is configured to produce the optical excitation signal 312 through lasing. According to various examples, the nanofinger nanolaser is the integral optical excitation source 310 and provides the optical excitation signal 312 through the lasing of the optical gain material within the optical cavity of the nanofinger nanolaser.

In some examples, the nanofinger nanolaser is substantially similar to the nanofinger 110 including a nanolaser described above with respect to the self-exciting SERS structure 100. In particular, the nanofinger nanolaser may be configured to produce the optical excitation signal 312 through either of optical pumping or electrical pumping by a pump source. Further, the nanofinger nanolaser with the nanoparticle disposed on the free end of the nanofinger nanolaser may be arranged in an ordered array of nanofinger nanolasers. The ordered array may be arranged on a supporting substrate, for example. In some examples, the ordered array of nanofinger nanolasers may include a multimer of nanofinger nanolasers. The multimer is configured to provide a SERS hotspot between adjacent ones of the nanoparticles disposed on the nanofinger nanolasers of the multimer. The multimer may be substantially similar to the multimer 116 described above with respect to the self-exciting SERS structure 100, for example. Optical pumping may be provided by an external optical pump source such as, but not limited to, a light emitting diode or a vertical cavity surface-emitting laser, for example.

In other examples, the SERS-enhancing structure 320 includes a plurality of nanofingers disposed on an output aperture of a vertical cavity surface-emitting laser (VCSEL). The nanofingers are disposed to provide a SERS hotspot when the SERS-enhancing structure 320 is illuminated by the optical excitation signal 312, for example. In these examples, the integral optical excitation source 310 includes the VCSEL. For example, the VCSEL may be configured to produce the optical excitation signal 312 and illuminate the plurality of nanofingers disposed on the VCSEL output aperture. In some examples, the SERS-enhancing structure 320 with the VCSEL acting as the integral optical excitation source 310 is substantially similar to the self-exciting SERS sensor 200, described above.

In particular, in some examples, the nanofingers include a SERS-enhancing material. For example, the nanofingers may include a metal. The nanofingers including a SERS-enhancing material may be substantially similar to the SERS-enhancing nanorods 212 described above with respect to the self-exciting SERS sensor 200, for example. Further, in some examples, the nanofingers have SERS-enhancing nanoparticles disposed on an end of the nanofingers. The nanofingers having the end-disposed SERS-enhancing nanoparticles may or may not also include a SERS-enhancing material, according to some examples. In some examples, the nanofingers having the end-disposed SERS-enhancing nanoparticles may be substantially similar to the nanofingers 214 having SERS-enhancing nanoparticles 216 disposed at an end of the nanofingers 214, as described above with respect to the self-exciting SERS sensor 200, for example.

Referring again to FIG. 8, the self-exciting SERS system 300 may further include a detector 330. The detector 330 may be configured to detect a Raman scattering signal 322 produced by an interaction between the SERS-enhancing structure 320 and an analyte in the vicinity of the SERS hotspot associated with illuminated SERS-enhancing structure 320. The detector 320 may be a spectrometer, for example.

Thus, there have been described examples of a self-exciting SERS substrate, a self-exciting SERS sensor and a self-exciting SERS system that include an integral optical excitation signal source to provide self-excitation of a Raman scattering signal. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A self-exciting surface enhanced Raman spectroscopy (SERS) structure comprising:
a plurality of nanofingers, a nanofinger of the plurality including a nanolaser that comprises an optical gain material to provide stimulated photon emission and an optical cavity to provide optical feedback, the nanolaser being an integral optical excitation source to provide a optical excitation signal through light amplification by the stimulated emission of radiation within the optical cavity; and
a nanoparticle disposed adjacent to the nanofingers and comprising a SERS-enhancing material, the optical excitation signal to illuminate the nanoparticle,
wherein the self-exciting SERS substrate is to produce a Raman scattering signal from an analyte in a vicinity of the illuminated nanoparticle.

2. The self-exciting SERS structure of claim 1, wherein the optical gain material comprises one or more of a III-V compound semiconductor and a II-VI compound semiconductor.

3. The self-exciting SERS substrate of claim 1, wherein the nanoparticle is disposed on a free end of the nanofingers opposite an end that is attached to a supporting substrate.

4. The self-exciting SERS substrate of claim 3, wherein the nanoparticle comprises a metal surface that is functionalized to preferentially adsorb the analyte.

5. The self-exciting SERS substrate of claim 3, wherein the nanofingers are arranged in an ordered array on the supporting substrate, the ordered array comprising a multimer of nanofingers to provide a SERS hotspot between adjacent ones of the nanoparticles disposed on the free ends of the nanofingers in the multimer.

6. The self-exciting SERS substrate of claim 1, wherein the nanofinger of the plurality further comprises a Bragg mirror to provide the optical cavity of the nanolaser.

7. The self-exciting SERS substrate of claim 6, wherein the Bragg mirror is adjacent to a free end of the nanofinger, the nanofinger further comprising another Bragg mirror adjacent to an end of the nanofinger adjacent to a supporting substrate, the optical cavity being provided between the Bragg mirrors.

8. The self-exciting SERS substrate of claim 1, wherein the nanolaser is to be optically pumped by an optical pump source to provide the optical excitation signal.

9. The self-exciting SERS substrate of claim 8, wherein the optical pump source comprises a vertical cavity surface-emitting laser (VCSEL), the plurality of nanofingers being disposed on a surface of an output aperture of the VCSEL.

10. The self-exciting SERS substrate of claim 1, wherein the nanolaser is to be electrically pumped by an electrical pump source to provide the optical excitation signal.

11. The self-exciting SERS substrate of claim 10, wherein the nanofinger of the plurality comprises a semiconductor junction and the electrical pump source comprises a voltage source connected across the semiconductor junction.

12. A self-exciting surface enhanced Raman spectroscopy (SERS) sensor comprising:
a SERS structure comprising one or both of a plurality of SERS-enhancing nanorods and a plurality of nanofingers having SERS-enhancing nanoparticles disposed at a free end of the nanofingers, the SERS-enhancing nanorods and the SERS-enhancing nanoparticles comprising a SERS-enhancing material; and
a vertical cavity surface-emitting laser (VCSEL) as an integral optical excitation source to produce an optical excitation signal at an output aperture of the VCSEL, the SERS structure being disposed on a surface of the output aperture of the VCSEL,
wherein the self-exciting SERS sensor is to produce a Raman scattering signal from an analyte in a vicinity of the SERS structure when excited by the optical excitation signal.

13. The self-exciting SERS sensor of claim 12, wherein the nanofingers of the plurality are attached to the output aperture surface at an end of the nanofingers opposite the free end, the nanofingers extending away from the output aperture surface.

14. The self-exciting SERS sensor of claim 13, wherein the nanofingers comprise a light guide to guide the optical excitation signal from the output aperture to the nanoparticles.

15. The self-exciting SERS sensor of claim 12, wherein the nanofingers are arranged in an ordered array on the output aperture surface, the ordered array comprising a multimer of adjacent nanofingers to provide a SERS hotspot between adjacent ones of the nanoparticles disposed on the free ends of the nanofingers in the multimer.

16. The self-exciting SERS sensor of claim 12, further comprising a thin film filter between the SERS structure and the VCSEL, the output aperture surface comprising the thin film filter.

17. A self-exciting surface enhanced Raman spectroscopy (SERS) system comprising:
an integral optical excitation source to provide an optical excitation signal; and
a SERS-enhancing structure comprising one of:
a SERS-enhancing nanoparticle disposed on an end of a nanofinger nanolaser, the nanofinger nanolaser comprising an optical gain material and an optical cavity, wherein the integral optical excitation source comprises the nanofinger nanolaser; and
a plurality of nanofingers disposed on an output aperture of a vertical cavity surface-emitting laser (VCSEL), wherein the integral optical excitation source comprises the VCSEL, and wherein either the nanofingers comprise a SERS-enhancing material or the nanofingers have SERS enhancing nanoparticles disposed on an end of the nanofingers,
wherein the SERS-enhancing structure is to be illuminated by the optical excitation signal.

18. The self-exciting SERS system of claim 17, wherein the nanofinger nanolaser is a member of a plurality of nanofinger nanolasers with SERS-enhancing nanoparticles disposed on the end of the nanofinger nanolasers, the nanofinger nanolasers being arranged in an ordered array on the supporting substrate, the ordered array comprising a multimer of the nanofinger nanolasers to provide a SERS hotspot between adjacent ones of the SERS-enhancing nanoparticles disposed on the nanofinger nanolasers of the multimer.

19. The self-exciting SERS system of claim 17, further comprising one of an optical pump source when the nanofinger nanolaser is to be optically pumped and an electrical pump source when the nanofinger nanolaser is to be electrically pumped.

20. The self-exciting SERS system of claim 17, further comprising a detector to detect a Raman scattering signal produced by an interaction between the SERS-enhancing structure and an analyte in the vicinity of a SERS hotspot associated with the illuminated SERS-enhancing structure.
